(19) United States
(12) Patent Application Publication
(10) Pub. No.: US 2014/0311704 A1
(43) Pub. Date: Oct. 23, 2014

(54) Cooling Apparatus

(71) Applicant: Hitachi Automotive Systems, Ltd., Hitachinaka-shi, Ibaraki (JP)

(72) Inventors: Atsushi Yokoyama, Tokyo (JP); Tadashi Osaka, Tokyo (JP); Yuki Akiyama, Tokyo (JP); Hideki Miyazaki, Hitachinaka (JP)

(21) Appl. No.: 14/355,070

(22) PCT Filed: Oct. 24, 2012
(86) PCT No.: PCT/JP2012/077391

§ 371 Date: Apr. 29, 2014

(30) Foreign Application Priority Data
Nov. 21, 2011 (JP) 2011-253925

(51) Int. Cl. B60H 1/00

(52) U.S. Cl. CPC B60H 1/00007
USPC 165/41

(57) ABSTRACT

A cooling apparatus for a vehicle includes a water cooling system that cools a cooled body by circulating cooling water; and a refrigeration cycle system that cools the cooling water to an outside air temperature or lower utilizing a gas liquid phase change of a refrigerant. The water cooling system includes a first flow passage that causes the cooling water cooled through a radiator radiating heat of the cooling water to outside air to flow through the cooled body; a second flow passage that causes the cooling water cooled to the outside air temperature or lower through an evaporator of the refrigeration cycle system 36 to flow through the cooled body provided at the first flow passage; and flow rate control units that control flow rates of the cooling water flowing in the first flow passage and the second flow passage.

### TECHNICAL FIELD

The present invention relates to a cooling apparatus and, for example, relates to a cooling apparatus of an electric vehicle which jointly uses a water cooling system and a refrigeration cycle system.

### BACKGROUND ART

In an electric vehicle, such as an electric car or a hybrid car, a power converter (inverter) converts DC power supplied from a high voltage storage battery (e.g., a lithium ion battery) into AC power, and a motor (e.g., a three-phase AC motor) is rotated using this AC power, thereby generating driving force of the vehicle. Further, when a speed of the vehicle is reduced, regenerative energy obtained by regenerative power generation of the motor is stored in the storage battery, thereby reducing waste of energy and realizing efficient energy utilization.

Incidentally, it is known that there is a possibility that the power converter used in the above-described electric vehicle, such as the electric car or the hybrid car, is thermally destroyed by heat generation which is caused by a switching operation of a switching element therein.

Further, it is also known that output characteristics of the motor, a charging/discharging performance or life characteristics of the storage battery, or the like have high temperature dependencies, and that it is necessary to maintain these within a proper temperature range in order to efficiently operate the storage battery or the motor.

In dealing with such problems, a conventional motor drive equipment designed to achieve both thermal protection of a power converter and power saving is disclosed in PTL 1.

The motor drive equipment disclosed in PTL 1 is an equipment in which, in a water cooling system which causes cooling water to flow through a motor, a power converter, or the like and cools the motor, the power converter, or the like, a target flow rate of the cooling water flowing through a refrigerant flow passage is set based on current command value of the motor, a water pump is driven in such a manner that the cooling water circulates at the set target flow rate, and the power converter is cooled with good responsiveness.

Further, a conventional set temperature maintaining apparatus of a storage battery for an electric car designed to maintain a temperature of the storage battery at a set temperature is disclosed in PTL 2.

The set temperature maintaining apparatus disclosed in PTL 2 is an apparatus which jointly uses a refrigeration cycle system for indoor cooling and a water cooling system for cooling the storage battery, and cools the storage battery by providing an intermediate heat exchanger between the refrigeration cycle system and the water cooling system and performing heat exchange therebetween.

### CITATION LIST

### Patent Literature

PTL 1: JP 2007-166804 A

PTL 2: JP 2006-296193 A

### SUMMARY OF INVENTION

### Technical Problem

According to the motor drive equipment disclosed in PTL 1, a cooling medium can be supplied with good responsiveness to the power converter where a temperature rise is expected, the power converter can be reliably protected from overheating, and an appropriate flow rate of the cooling medium can be supplied against the temperature rise of the power converter which fluctuates in response to an output of the motor. Further, for example, compared to a motor drive equipment in which a supply rate of the cooling medium has to be set to the maximum due to insufficient responsiveness, power consumption of the cooling apparatus of the motor drive equipment can be suppressed.

Further, according to the set temperature maintaining apparatus disclosed in PTL 2, the intermediate heat exchanger is provided between the refrigeration cycle system and the water cooling system, and the water cooling system which causes the cooling water to flow through the storage battery is controlled by a temperature adjusting unit. Consequently, the storage battery can be efficiently cooled.

However, in the motor drive equipment disclosed in PTL 1, in a case where a radiator configuring the water cooling system is mounted in a vicinity of a bumper on a front side of a vehicle, the radiator and the motor or the like are located separately, and a piping length for circulating the cooling water in the water cooling system becomes longer. Therefore, even if the driving of the pump for cooling water is controlled and the flow rate of the cooling water is increased, a time at which the cooling water cooled by the radiator reaches the motor or the power converter becomes longer, and there is a possibility that the temperature of the cooling water is raised and the cooling performance of the motor or the power converter is lowered. Further, since a volume of the cooling water, that is, a heat capacity of the cooling water inside the piping is increased, there is also a problem such that it is difficult to efficiently cool the entire cooling water to a predetermined temperature. Moreover, since vibration propagation by drive torque of the motor is blocked from the inverter or a vehicle body skeleton, it is necessary to connect the motor and the inverter with a pipe formed of an elastic body, such as a rubber hose, and there as a possibility that the cooling performance of the motor or the power converter is further lowered. With this configuration, in a case where the rapid temperature rise is expected in the motor, the power converter, or the like so as to correspond to, for example, a rapid acceleration operation of a driver or a travel condition, such as a rapid change of a travel load, there is a problem such that the motor, the power converter, or the like cannot be cooled with good responsiveness.

Further, in the set temperature maintaining apparatus disclosed in PTL 2 as well, a piping length of the cooling water configuring the cooling system becomes relatively long in the same way as the motor drive equipment disclosed in PTL 1. Consequently, even if the temperature of the cooling water is lowered using the refrigeration cycle system, there is a problem such that a heat capacity of the cooling water is increased and excellent responsiveness to cooling cannot be obtained.

In consideration of the above-described problems, it is an object of the invention to provide a cooling apparatus capable of securing excellent responsiveness to cooling in the cooling apparatus which jointly uses a refrigeration cycle system and a water cooling system.

### Solution to Problem

In order to solve the above problem, the present invention relates to a cooling apparatus in which at least one of a motor generating a driving force of a vehicle, a power converter controlling driving power of the motor, a storage battery supplying power to the power converter serves as a cooled body, the cooling apparatus including: a first cooling system which cools the cooled body by causing a cooling medium to flow through the cooled body; and a second cooling system which cools the cooling medium of the first cooling system to an outside air temperature or lower, wherein the first cooling system includes a first flow passage which causes the cooling medium cooled through a radiator radiating heat of the cooling medium to outside air to flow through the cooled body, a second flow passage which causes the cooling medium cooled to the outside air temperature or lower through the second cooling system to flow through she cooled body provided at the first flow passage, and a flow rate control unit which controls a flow rate of the cooling medium flowing in the first flow passage and the second flow passage.

### Advantageous Effects of Invention

According to the cooling apparatus of the present invention, by configuring the first cooling system for cooling the cooled body from the first flow passage which cools the cooling medium using the radiator and the second flow passage which cools the cooling medium using the second cooling system, the flow rate of the cooling medium in the second flow passage, particularly the heat capacity of the cooling medium at the time of cooling strengthening, can be reduced. Consequently, the cooling medium flowing through the cooled body can be efficiently cooled, and the cooled body can be cooled with good responsiveness.

Problems, structures, and effects other than those described above will be apparent from the following description of embodiments.

### BRIEF DESCRIPTION OF DRAWINGS

FIG. 1 is an internal structural illustrating a basic structure of a front side interior of a vehicle, to which Embodiment 1 of a cooling apparatus according to the present invention is applied.

FIG. 2 is a diagram illustrating in time series an example of a temperature change of a power converter in a case where the temperature of the power converter or the like is controlled using the cooling apparatus illustrated in FIG. 1.

FIG. 3 is a diagram illustrating in time series another example of a temperature change of the power converter in a case where the temperature of the power converter or the like is controlled using the cooling apparatus illustrated in FIG. 1.

FIG. 4 is an internal structural view illustrating a basic structure of a front, side interior of a vehicle, to which Embodiment 2 of a cooling apparatus according to the present invention is applied.

### DESCRIPTION OF EMBODIMENTS

Hereinafter, embodiments of cooling apparatuses according to the present invention will be described with reference to the drawings.

### Embodiment 1

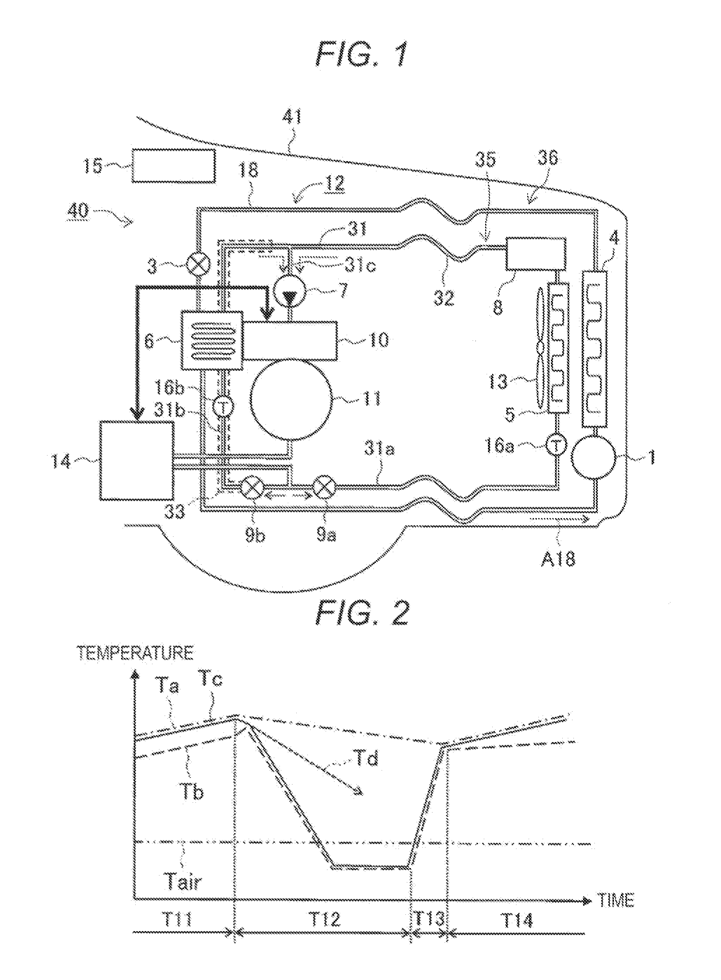

FIG. 1 illustrates a basic structure of a front side interior of a vehicle, to which Embodiment 1 of a cooling apparatus according to the present invention is applied. Here, in the illustrated example, a cooing apparatus 12 of Embodiment 1 is applied to an electric vehicle of a front wheel drive system. A right side in the drawing is a traveling direction of a vehicle 41, and an electric drive system 40 including a power converter 10, a motor 11, or the like is mounted in a vicinity of a front wheel of the vehicle 41. It should be noted that the cooling apparatus 12 of Embodiment 1 is also applicable to an electric vehicle with a rear wheel drive system or a four-wheel drive system, a hybrid electric vehicle equipped with an engine, or the like.

The illustrated electric drive system 40 of the electric vehicle 41 includes a storage battery 14 which stores driving energy, the power converter 10 which controls driving power supplying to the motor 11 using power supplied from the storage battery 14, the motor 11 which generates rotation torque (driving force) of a wheel using the driving power supplied from the power converter 10, and the cooling apparatus 12 which cools the power converter 10, the motor 11, or the storage battery 14.

Further, the above-described cooling apparatus includes a refrigeration cycle system (second cooling system) 36 and a water cooling system (first cooling system) 35.

The above-described refrigeration cycle system 36 includes a compressor 1, a condenser 4, a pressure reducer (expansion valve) 3, an evaporator 6, and a refrigerant piping 18. A fan 13 is attached to the condenser 4 and capable of controlling a flow rate of cooling air based on a command signal of a controller 15. Here, a refrigerant which is suitable for the refrigeration cycle, such as alternative Freon, circulates in the refrigerant piping 18 connecting the compressor 1, the condenser 4, the pressure reducer 3, and the evaporator 6. This refrigerant circulates in the refrigerant piping 18 and is cooled by the refrigeration cycle where the compressor 1 serves as a power source.

Further, the above-described water cooling system 35 includes a radiator 5, a reservoir 8, a pump 7, flow rate control valves (flow rate control unit) 9a, 9b, the evaporator 6 (shared with the refrigeration cycle system 36), and a flow passage 31 for cooling water. The fan 13, which is shared with the above-described condenser 4, is attached to the radiator 5 and capable or controlling the flow rate of cooling air based on the command signal of the controller 15. Here, cooling water, such as antifreeze, circulates in the flow passage 31 of the water cooling system 35 connecting the radiator 5, the reservoir 8, the pump 7, the flow rate control valves 9a, 9b, the evaporator 6, the power converter 10, the motor 11, and the storage battery 14.

It should be noted that the illustrated controller 15 drives and controls the compressor 1, the fan 13, the pump 7, the flow rate control valves 9a, 9b, and the like according, to conditions of the power converter 10, the motor 11, or the storage battery 14 and the cooling water or the refrigerant, detected by a temperature sensor, a pressure sensor, or the like (not illustrated), and is capable of controlling temperatures of the refrigerant of the refrigeration cycle system 36 and the cooling water of the water cooling system 35.

Here, the flow passage 31 for cooling water of the above-described water cooling system 35 includes a first flow passage 31a connecting the radiator 5, the reservoir 8, the pump 7, the power converter 10, the motor 11, and the storage battery 14 and a second flow passage 31b connecting the evaporator 6, the pump 7, the power converter 10, the motor 11, and the storage battery 14. In other words, the first flow passage 31a and the second flow passage 31b share a portion 31c connecting the pump 7, the power converter 10, the motor 11, and the storage battery 14. The second flow passage 31b is formed by branching off a flow passage of the first flow passage 31a passing through the pump 7, the power converter 10, the motor 11, and the storage battery 14 and again merging the branched flow passage with the first flow passage 31a at an upper stream of the pump 7. The cooling water in both of the first flow passage 31a and the second flow passage 31b is pressure-fed using the pump 7 provided at the above-described shared portion 31c as the power source. It should be noted that the reservoir 8 provided at the first flow passage 31a absorbs volume change due to thermal expansion, leakage, or the like of the cooling water flowing in the first flow passage 31a. Further, the respective first flow passage 31a and the second flow passage 31b can be separate flow passages having no shared portion 31c.

Moreover, the first flow passage 31a and the second flow passage 31b respectively include the above-described flow rate control valves 9a, 9b and temperature sensors 16a, 16b detecting a temperature of the cooling water. With this configuration, a rotation speed of the pump 7 or opening degrees of the flow rate control valves 9a, 9b can be separately changed according to a drive condition of the power converter 10, the motor 11, or the storage battery 14 or measurement values of the temperature sensors 16a, 16b, and the flow rates of the cooling water flowing in the first flow passage 31a and the second flow passage 31b can be respectively controlled.

In this way, the radiator 5 and the evaporator 6 of the refrigeration cycle system 36 are connected in parallel to the power converter 10, the motor 11, and the storage battery 14 to be cooled, the pump 7 is shared by the first flow passage and the second flow passage, and proportions of the flow rates of the cooling water flowing in the first flow passage and the second flow passage are respectively controlled by the flow rate control valves 9a, 9b. Accordingly, an increase in a cardinal number of the pumps 7 can be suppressed, and a structure of the cooling apparatus 12 can be simplified.

Further, by respectively providing the temperature sensors 16a, 16b at the first flow passage 31a and the second flow passage 31b, even in a case where water temperatures of the cooling water flowing in the respective flow passages are different, the flow rates of the cooling water in the first flow passage 31a and the second flow passage 31b can be controlled based on these water temperatures. It should be noted that the water temperature of the shared portion 31c of the first flow passage 31a and the second flow passage 31b can be estimated from the above-described two temperature sensors 16a, 16b and the opening degrees of the flow rate control valves 9a, 9b. For example, in a case where the flow rate control valve 9a is opened and the flow rate control valve 9b is closed, it can be estimated that the water temperature of the cooling water flowing in the shared portion 31c is substantially the same as the measurement value of the temperature sensor 16a provided at the first flow passage 31a. Further, in a case where the flow rate control valve 9a is closed and the flow rate control valve 9b is opened, it can be estimated that the water temperature of the cooling water flowing in the shared portion 31c is substantially the same as the measurement value of the temperature sensor 16b provided at the second flow passage 31b. By performing such temperature estimation, she increase in the cardinal number of the temperature sensors can be suppressed, and the structure of the cooling apparatus 12 can be simplified. It should be noted that, if the temperature sensor is provided at the shared portion 31c of the flow passage 31, inside the power converter 10, or inside the motor 11, the temperature control can be performed more precisely.

Here, the cooling water circulating in the first flow passage 31a is cooled by air which passes through the radiator 5 connected to the first flow passage 31a. According to such cooling by the radiator 5, while the cooling water flowing in the first flow passage 31a cannot be cooled to an outside air temperature or lower, since the power consumption of the pump 7 or the fan 13 is smaller than the power consumption of the compressor 1, the cooling water can be cooled with a small amount of power consumption.

Further, the cooling water circulating in the second flow passage 31b is cooled by the refrigerant passing through the evaporator 6 of the refrigeration cycle system 36. The refrigerant circulating in the refrigerant piping 18 connected to the evaporator 6 of the refrigeration cycle system 36 is pressure-fed to the condenser 4 by the compressor 1, and is cooled by this condenser 4. While power consumption of such cooling using the refrigeration system 36 is relatively larger than that of the cooling by the radiator 5, the cooling water can be cooled to the outside air temperature or lower. Therefore, even in a case where a load of the power converter 10, the motor 11, or the storage battery 14 is high, these can be cooled by the cooling water with a temperature lower than the cooling water of the first flow passage 31a, and the temperature rise of the power converter 10, the motor 11, or the storage battery 14 can be effectively suppressed.

It should be noted that a part of the second flow passage 31b other than the shared portion 31c with the first flow passage 31a is covered with a member 33 having high insulation performance, such as a foamed material. With this configuration, heat input from outside air to the cooling water cooled to the outside air temperature or lower can be suppressed, and the power consumption of the compressor 1 can be effectively suppressed.

With such configuration, in the above-described cooling apparatus 12, temperatures of the refrigerant of the refrigeration cycle system 36 and the cooling water of the water cooling system 35 can be changed by controlling operation states of the compressor 1 of the refrigeration cycle system 36, the pump 7 and the flow rate control valves 9a, 9b of the water cooling system 35, and the fan 13.

For example, in a case where the load of the power converter 10, the motor 11, or the storage battery 14 is low and heat generation amounts thereof are relatively small, the cooling water is circulated only in the first flow passage 31a by controlling the flow rate control valves 9a, 9b, and the heat of the cooling water radiated from the radiator 5, thereby cooling the cooling water. With this configuration, the cooling water of the water cooling system 35 can be cooled with small power.

On the other hand, for example, in a case where the load of the power converter 10, the motor 11, or the storage battery 14 is high, the heat generation amounts thereof are large, and the cooling water needs to be cooled to a temperature lower than the outside air temperature, the cooling water is circulated only in the second flow passage 31b by controlling the flow rate control valves 9a, 9b, and the heat of the cooling water is radiated through the evaporator 6 of the refrigeration cycle system. 36, thereby cooling the cooling water. With this configuration, even in the case where the load of the power converter 10, the motor 11, or the storage battery 14 is high, the cooling water flowing therethrough is reliably cooled, and the temperature rise of the power converter 10, the motor 11, or the storage battery 14 can be suppressed.

As illustrated, it should be noted that the power converter 10 is supported by the motor 11. Further, the power converter 10 and the motor 11 are connected to tires through a speed reducer (not illustrated). Here, the power converter 10 and the motor 11 are supported by a vehicle body through an elastic body, such as rubber, in such a manner that vibration due to the drive torque is not propagated to the vehicle body. On the other hand, the radiator 5 and the condenser 4 are provided in the vicinity of the bumper on the front side of the vehicle body. Therefore, the power converter 10 or the motor 11 and the radiator 5 are connected by a rubber hose 32 in order to absorb relative displacement between the power converter 10 or the motor 11 and the radiator 5 generated by the vibration of the power converter 10 or the motor 11.

In this way, in the first flow passage 31a of the water cooling system 35, it is necessary to have some distance between the power converter 10 or the motor 11 and the radiator 5, and is necessary to cause the cooling water to flow through the inside of the radiator 5 and the reservoir 8 as well. Further, since a part of the first flow passage 31a needs to be constituted of the rubber hose 32, the flow rate of the cooling water flowing in the first flow passage 31a is relatively increased, and it is difficult to cool the cooling water with good responsiveness.

On the other hand, regarding she second flow passage 31b of the water cooling system 35, since it is not necessary to provide the flow passage to the front side of the vehicle as the first flow passage 31a, the power converter 10, the motor 11, or the storage battery 14, and the evaporator 6 can be constituted by connecting through relatively short flow passages. Further, since the evaporator 6 can be supported by the power converter 10, it is not necessary to connect the evaporator 6 and the power converter 10 or the motor 11 through a rubber hose or the like. Moreover, if the reservoir 8 and the radiator 5 are provided at the first flow passage 31a, the flow rate of the cooling water in the second flow passage 31b to be cooled by the refrigeration cycle system 36 can be suppressed.

With this configuration, even in a case where the control in which the cooling water flowing in the second flow passage 31b is cooled to the predetermined temperature is performed in order to cool the power converter 10, the motor 11, or the storage battery 14, a heat capacity or the cooling water can be made small, and the water temperature can be lowered in a relatively short and long period of time. Consequently, the cooling water flowing in the second flow passage 31b can be efficiently cooled.

It should be noted that the evaporator 6 has a structure supported by the power converter 10 in Embodiment 1, but the evaporator 6 may be supported by the motor 11 or the storage battery 14. Moreover, though the rubber hose or the like is needed for the flow passage, for example, even if the evaporator 6 is supported by the vehicle body 41, the heat capacity related to the cooling water of the reservoir 8 and the radiator 5 can be reduced.

Next, a cooling method of the cooling water in the water cooling system 35 by she cooling apparatus 12 of the present Embodiment 1 will be described.

First, a cooling method of the cooling water flowing in the first flow passage 31a will be described.

In a case where the load of the power converter 10, the motor 11, or the storage battery 14 is low and the heat generation amounts thereof are relatively small, the controller 15 illustrated in FIG. 1 opens the flow rate control valve 9a of the first flow passage 31a, closes the flow rate control, valve 9b of the second flow passage 31b, and circulates the cooling water only in the first flow passage 31a. The cooling water circulating in the first flow passage 31a absorbs the heat of the power converter 10, the motor 11, and the storage battery 14 during the circulation, and the water temperature thereof is increased. The cooling water whose temperature has been increased in this way flows into the radiator 5 through the flow rate control valve 9a. Here, the outside air whose temperature is lower than that of the cooling water passes through the radiator 5, and the heat of the cooling water is radiated to the outside air.

The controller 15 controls revolution speeds of the pump 7 and the fan 13 in response to the temperatures of the cooling water and the outside air, the heat generation amount of the power converter 10, the motor 11, or the storage battery 14, and a travel speed or the like of the vehicle 41. Here, the revolution speeds of the pump 7 and the fan 13 are controlled so as to have minimum power consumption capable of obtaining a cooling capacity to be needed.

For example, if the temperature of the cooling water is lower than the predetermined temperature, rotations of the pump 7 and the fan 13 are stopped, or the pump 7 and the fan 13 are driven at the minimum revolution speeds. Further, if the travel speed of the vehicle 41 is fast, since the air quantity of the radiator 5 can be secured by traveling wind, the driving of the fan 13 is stopped. Moreover, in a case where the temperature of the cooling water exceeds or is predicted to exceed the predetermined temperature, the revolution speeds of the pump 7 and the fan 13 are raised, and the cooling capacity is increased. It should be noted that, according to such cooling method of the cooling water flowing in the first flow passage 31a, though the cooling capacity is limited as described above, there is no need to drive the compressor 1. Accordingly, the cooling water flowing in the first flow passage 31a can be cooled with the small amount of power consumption.

Next, a cooling method of the cooling water flowing in the second flow passage 31b will be described.

In a case where the load of the power converter 10, the motor 11, or the storage battery 14 is high and the heat generation amounts thereof are relatively large, the controller 15 illustrated in FIG. 1 opens the flow rate control valve 9b of the second flow passage 31b, closes the flow rate control valve as of the first flow passage 31a, and circulates the cooling water only in the second flow passage 31b. Here, the cooling water in the second flow passage 31b is pressure-fed by the pump 7, and the controller 15 is capable of adjusting the flow rate of the cooling water flowing in the second flow passage 31b by controlling the revolution speed of the pump 7. The cooling water flowing in the second flow passage 31b absorbs the heat of the power converter 10, the motor 11, and the storage battery 14 during the circulation, and the water temperature thereof is increased. The cooling water whose temperature has been increased in this way flows into the evaporator 6 through the flow rate control valve 9b. Then, the cooling water is heat-exchanged with the refrigerant of the refrigeration cycle system 36 at the evaporator 6, and the water temperature thereof is lowered.

Here, the refrigerant inside the refrigerant piping 18 of the refrigeration cycle system 36 is circulated in a direction of an arrow A18 by the compressor 1. The refrigerant is compressed to be high temperature and high pressure gas in the compressor 1, and then is condensed in the condenser 4 by discharging the heat in the air, thereby becoming high pressure liquid. After flowing in the refrigerant piping 18, the refrigerant is depressurized by the pressure reducer 3 to be a low pressure and low temperature refrigerant (two-layer refrigerant of liquid and gas). After that, the refrigerant is heat-exchanged with the cooling water flowing in the second flow passage 31b through the evaporator 6. Therefore, by controlling the driving state of the compressor 1, the controller 15 is capable of adjusting the temperature and the flow rate of the refrigerant and adjusting the water temperature of the cooling water flowing in the second flow passage 31b.

In this way, in response to the output of the power converter 10, the motor 11, or the storage battery 14 serving as a heat generating body, the flow rate control valves 9a, 9b provided at the first flow passage 31a and the second flow passage 31b are controlled, and the flow rates of the cooling water in the first flow passage 31a and the second flow passage 31b are controlled. Consequently, even in a case where the high cooling capacity is required, the cooling water can be cooled with good responsiveness and the heat generating bodies can be cooled.

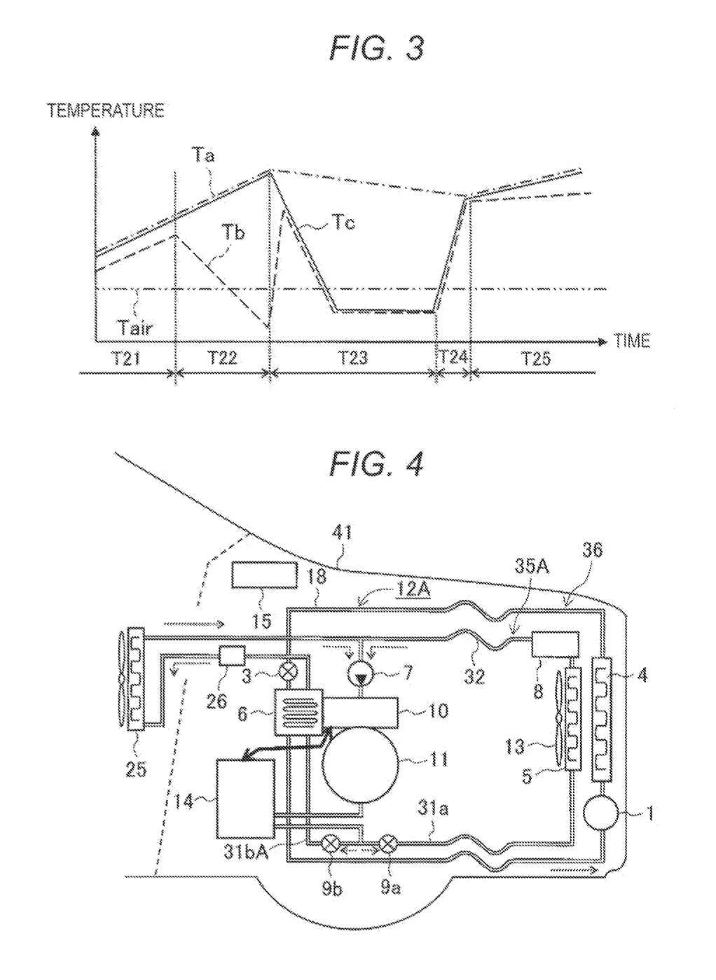

Next, referring to FIGS. 2 and 3, a method of controlling a temperature of the power converter 10 using the cooling apparatus 12 illustrated in FIG. 1 will be described more specifically. It should be noted that, this controlling method involves switching of the flow passage of the cooling water from the first flow passage 31a to the second flow passage 31b.

FIG. 2 illustrates in time series an example of a temperature change of the power converter 10 in a case where the temperature of the power converter 10 is controlled using the cooling apparatus 12 illustrated in FIG. 1. FIG. 2 illustrates a water temperature Ta of the cooling water in a vicinity of the radiator 5 detected by the temperature sensor 16a in the first flow passage 31a, a water temperature Tb of the cooling water in a vicinity of the evaporator 6 detected by the temperature sensor 16b in the second flow passage 31b, a water temperature Tc of the cooling water flowing through the power converter 10 estimated by the temperature sensors 16a, 16b, and an outside air temperature Tair.

First, in a section T11, the heat generation amount from the power converter 10 is relatively small, and the cooling water is circulated in the first flow passage 31a and cooled by the radiator 5.

Next, in a section T12, the flow passage of the cooling water is switched from the first flow passage 31a to the second flow passage 31b. For example, in a case where a driver depresses an accelerator pedal for a predetermined amount or more, in a case where a shift lever is switched to a position of high output travel, and in a case where uphill traveling or high speed traveling is predicted from route information, such as navigation system, it is predicted that the load of the power converter 10, she motor 11, or the storage battery 14 becomes high, and that the heat generation amounts thereof are relatively larger than the predetermined value. Consequently, the flow passage of the cooling water is switched from the first flow passage 31a to the second flow passage 31b, and the cooling water is cooled to the predetermined temperature or lower, thereby suppression the temperature rise of the power converter 10, the motor 11, or the storage battery 14. With this configuration, thermal restrictions on the power converter 10, the motor 11, or the storage battery 14 can be relaxed, and high output of the power converter 10, the motor 11, or the storage battery 14 can be realized.

Specifically, in the case where the heat generation amount from the power converter 10 or the motor 11 is predicted to be larger than the predetermined value or in the case where the heat generation amount thereof has become large as described above, the controller 15 closes the flow rate control valve 9a of the first flow passage 31a, opens the flow rate control valve 9b of the second flow passage 31b, and circulates the cooling water in the second flow passage 31b. At that time, since the water temperature Tb of the cooling water retained in the second flow passage 31b is lower than the water temperature Ta of the cooling water in the first flow passage 31a (see the section T11), the water temperature Tc of the cooling water flowing through the power converter 10 slightly lowers.

When the compressor 1 is driven simultaneously with the driving of the above-described flow rate control valves 9a, 9b to start the cooling of the cooling water through the evaporator 6, the water temperature Tb of the cooling water in the second flow passage 31b and the water temperature Tc of the cooling water flowing through the power converter 10 are gradually lowered. It should be rioted that the water temperature of the cooling water can be controlled to an arbitrary temperature by the controller 15. Here, according to the refrigeration cycle system 36, since a cooled body (the power converter 10 or the like) can be cooled to the temperature lower than an object to be radiated (the outside air or the like), the cooling water can be cooled to the temperature lower than the outside air temperature Tair.

In this section T12, the cooling water serving as an object to be cooled is only the cooling water in the second flow passage 31b whose heat capacity is relatively small. Consequently, for example, compared to a case where the entire cooling water of the water cooling system 35 is cooled, the cooling water can be cooled rapidly to the predetermined temperature. It should be noted that a dotted line Td in FIG. 2 schematically illustrates a change of the water temperature Td in a case where the entire cooling water of the water cooling system 35 is cooled.

Next, as in a section T13, in a case where the load of the power converter 10, the motor 11, or the storage battery 14 is lowered and the heat generation amounts thereof are lowered, the controller 15 stops the compressor 1 of the refrigeration cycle system 36. However, within a predetermined period of time, the circulation of the cooling water in the second flow passage 31b is continued, and the power converter 10, the motor 11, or the storage battery 14 is cooled using the cooling water which had the relatively low temperature. With this configuration, driving of the fan 13 attached to the radiator 5 in the first flow passage 31a is omitted, and the power consumption of the cooling apparatus 12 can be suppressed.

Then, as in a section T14, in a case where the water temperature Tb of the cooling water flowing in the second flow passage 31b rises to the water temperature Ta of the cooling water flowing in the first flow passage 31a, the flow rate control valve 9a of the first flow passage 31a is opened, and the flow rate control valve 9b of the second flow passage 31b is closed. Accordingly, the cooling water is again circulated in the first flow passage 31a and subjected to cooling by the radiator 5.

FIG. 3 illustrates in time series another example of a temperature change of the power converter 10 in a case where the temperature of the power converter 10 is controlled using the cooling apparatus 12 illustrated in FIG. 1. In this example illustrated in FIG. 3, a standby control in which the cooling water retained in the vicinity of the evaporator 6 is previously cooled before the flow passage of the cooling water is shifted from the first flow passage 31a to the second flow passage 31b.

First, in a section T21, the heat generation amount of the power converter 10 is relatively small, and the cooling water is circulated in the first flow passage 31a and cooled by the radiator 5.

Next, in a section T22, in a state in which the flow rate control valve 9a of the first flow passage 31a is opened, the flow rate control valve 9b of the second flow passage 31b is closed, and the cooling water is circulated in the first flow passage 31a, the compressor 1 of the refrigeration cycle system 36 is driven, and the water temperature Tb of the cooling water in the vicinity of the evaporator 6 is lowered to a temperature lower than the outside air temperature Tair. As described above, it should be noted that, since the flow passage of the second flow passage 31b is covered with the member 33 having high insulation performance, the power consumption of the compressor 1 for holding a low temperature state can be suppressed.

Then, by switching the flow passage of the cooling water to the second flow passage 31b (a section T23) from the state of the section T22, it is possible to lower more rapidly the water temperature Tb of the cooling water circulating in the second flow passage 31b and the water temperature Tc of the cooling water flowing through the power converter 10. It should be noted that such standby control can be executed, for example, in a case where, while a high load operation of the power converter 10, the motor 11, the storage battery 14, or the like is predicted from tendency of the temperature to rise or the like, the prediction is uncertain.

By having such structure, compared to the case where the switching of the flow passage of the cooling, water and the driving of the compressor 1 are simultaneously performed as illustrated in FIG. 2, for example, the power consumption of the compressor 1 can be effectively suppressed. Further, in a case where the low temperature cooling water is actually needed, the cooling water can be cooled to the predetermined temperature in a short time, and an output response of the power converter 10, the motor 11, or the storage battery 14 can be remarkably improved.

As described above, the two flow passages 31a, 31b are provided in parallel to the power converter 10, the motor 11, or the storage battery 14 serving as a drive device of the electric drive system 40, and the radiator 5 and the evaporator 6 are connected to the respective flow passages. Accordingly, even in the case where the heat generation amount of the drive device is large, the cooling water can be cooled to the predetermined temperature in a short time, and the drive device of the electric vehicle can be cooled with good responsiveness. Therefore, the output of the drive device can be effectively improved.

### Embodiment 2

FIG. 4 illustrates a basic structure of a front side interior of a vehicle, to which Embodiment 2 of a cooling apparatus according to the present invention is applied. In Embodiment 2, the above-described second flow passage 31b of the water cooling system 35 of Embodiment 1 also serves as a flow passage for heating a vehicle cabin, and the other structures are the same as those in Embodiment 1. Consequently, the structures which are the same as those in Embodiment 1 are denoted using the same reference numerals, and detailed descriptions thereof are omitted.

In an illustrated cooling apparatus 12A of Embodiment 2, with respect to the above-described cooling apparatus 12 of Embodiment 1, a heater core (heat exchanger) 25 and a heater element 26 for heating a vehicle cabin are attached to a second flow passage 31bA of a water cooling system 35A. The above-described heater core 25 is a device which heats air introduced into the vehicle cabin by warm water. Further, the above-described heater element 26 is a device which converts electricity into heat and is, for example, a heating resistor, should be noted that, since the second flow passage 31bA also serves as the flow passage for heating a vehicle cabin, it is relatively longer than the second flow passage 31b of Embodiment 1, and an amount of water of she cooling water flowing in the second flow passage 31bA is relatively larger than the amount of water of the cooling water flowing in the second flow passage 31b of Embodiment 1.

In an environment in which the outside air temperature is low and the vehicle cabin heating is needed (e.g., winter), an amount of heat discharged from surfaces or the like of a power converter 10, a motor 11, and a storage battery 14 becomes large, it is not necessary to cool positively the power converter 10, the motor 11, and the storage battery 14 using a refrigeration cycle system 36, and the heat discharged from the power converter 10, the motor 11, and the storage battery 14 can be utilized for heating of the vehicle cabin. In other words, the cooling water heated by the heat discharged from the power converter 10, the motor 11, and the storage battery 14 is further heated to an appropriate temperature using the heater element 26 and utilized as heat for heating a vehicle cabin in the heater core 25.

It should be noted that, in an environment in which the outside air temperature is from a normal temperature to a high temperature and the vehicle cabin heating is not needed (e.g., summer), a heating function is not required. Accordingly, similarly to she above-described cooling apparatus 12 of Embodiment 1, in a case where the heat generation amounts of the power converter 10, the motor 11, the storage battery 14, and the like are small, and the cooling water is cooled by circulating the cooling water in she first flow passage 31a of the water cooling system 35A, the cooling water retained in the second flow passage 31bA is maintained at a comparatively low temperature. Then, in case where the heat generation amounts of the power converter 10, the motor 11, the storage battery 14, and the like become large and it is necessary to further cool the cooling water, the flow passage of the cooling water is switched to the second flow passage 31bA, and the cooling water is circulated in the second flow passage 31bA, thereby cooling the cooling water. Here, immediately after the flow passage of the cooling water is switched from a first flow passage 31a to the second flow passage 31bA, an amount of the cooling water larger than that of the cooling apparatus 12 of Embodiment 1 circulates. Accordingly, the power converter 10, the motor 11, and the storage battery 14 can be cooled more rapidly.

It should be noted that, in the above-described Embodiments 1, 2, the cooling water is used as the cooling medium using in the water cooling systems 35, 35A of the cooling apparatuses 12, 12A. However, oil may be used as the cooling medium. By utilizing characteristics of oil having low conductivity, such oil cooling system is capable of directly cooling an inside of the motor and also serving as a lubrication function.

Further, in the above-described Embodiments 1, 2, the refrigeration cycle system 36 is used as a unit for cooling the cooling water flowing in the second flow passage. However, other units may be used as long as the unit is capable of performing heat transport. For example, instead of the evaporator 6 of the refrigeration cycle system 36, a thermoelectric element, such as a Peltier element, may be used.

Moreover, in the above-described. Embodiments 1, 2, the description has been given of the structure in which, when the heat generation amount from the power converter 10, the motor 11, or the storage battery 14 becomes large, the flow passage of the cooling water is switched from the first flow passage to the second flow passage using the flow rate control valves 9a, 9b. However, for example, both of the flow rate control valves 9a, 9b are opened, and by adjusting the valve opening degrees thereof, the water temperature of the cooling water flowing in the flow passages of the water cooling systems 35, 35A may be adjusted.

Further, in the above-described Embodiments 1, 2, the description has been given of the structure in which the power converter 10, the motor 11, or the storage battery 14 serving as the drive device of the electric drive system 40 is cooled. However, according to each heat generation amount, arranged place, or the like, a cooled body which becomes an object to be cooled can be appropriately selected from among the power converter 10, the motor 11, and the storage battery 14.

It should be noted that the present invention is not limited to the above-described Embodiments 1, 2 and includes various variations. For example, the above-described Embodiments 1, 2 are detailed descriptions for clearly describing the present invention, and are not necessarily limited to those which include all the structures described.

Further, a part of a structure of one embodiment can be replaced with a structure of another embodiment, and further, the structure of the other embodiment can be added to the structure of the one embodiment. Moreover, addition, deletion, and replacement of the other structure is possible regarding a part of the structure of each Embodiment 1, 2.

Furthermore, control lines or information lines which are necessary for the description are illustrated, and all the control lines and the information lines are not necessarily illustrated on a manufactured product. Actually, it may be assumed that almost all the structures are connected to each other.

### REFERENCE SIGNS LIST

1 compressor
3 pressure reducer
4 condenser
5 radiator
6 evaporator
7 pump
8 reservoir
9a, 9b flow rate control valve (flow rate control unit)
10 power converter (cooled body)
11 motor (cooled body)
12 cooling apparatus
13 fan
14 storage battery (cooled body)
15 controller
16a, 16b temperature sensor
18 refrigerant piping
25 beater core (heat exchanger)
26 heater element
31 flow passage of water cooling system
31a first flow passage
31b second flow passage
31c shared portion
32 rubber hose
35 water cooling system (first cooling system)
36 refrigeration cycle system (second cooling system)
40 electric drive system
41 vehicle

1. A cooling apparatus in which at least one of a motor generating a driving force of a vehicle, a power converter controlling driving power of the motor, a storage battery supplying power to the power converter serves as a cooled body, the cooling apparatus comprising:
a first cooling system which cools the cooled body by causing a cooling medium to flow through the cooled body; and a second cooling system which cools the cooling medium of the first cooling system to an outside air temperature or lower,
wherein the first cooling system comprises a first flow passage which causes the cooling medium cooled through a radiator radiating heat of the cooling medium to outside air to flow through the cooled body, a second flow passage which causes the cooling medium cooled to the outside air temperature or lower through the second cooling system to flow through the cooled body provided at the first flow passage, and a flow rate control unit which controls a flow rate of the cooling medium flowing in the first flow pas sage and the second flow passage.

2. The cooling apparatus according to claim 1, wherein the flow rate control unit changes the flow rate of the cooling medium flowing in the first flow passage and the second flow passage in response to a heat generation amount of the cooled body.

3. The cooling apparatus according to claim 2, wherein, as the heat generation amount of the cooled body becomes large, the flow rate control unit increases the flow rate of the cooling medium in the second flow passage with respect to the first flow passage.

4. The cooling apparatus according to claim 1, wherein the second flow passage is covered with a member having higher insulation performance than the first flow passage.

5. The cooling apparatus according to claim 1, wherein the second flow passage comprises a heat exchanger for heating a vehicle cabin.

6. The cooling apparatus according to claim 1, wherein the first cooling system comprises a water cooling system which uses cooling water as the cooling medium and cools the cooled body by circulating the cooling water, and the second cooling system comprises a refrigeration cycle system which utilizes a gas liquid phase change of a refrigerant and cools the cooling water by circulating the refrigerant, and
in the first flow passage of the first cooling system, the cooling water is cooled by radiating the heat of the cooling medium to the outside air through the radiator, and in the second flow passage, the cooling water is cooled by radiating the heat of the cooling water to the refrigerant of the refrigeration cycle system through an evaporator of the refrigeration cycle system.

7. The cooling apparatus according to claim 6, wherein the first flow passage of the water cooling system comprises a reservoir for absorbing a volume change of the cooling water.

8. The cooling apparatus according to claim 6, wherein the evaporator of the refrigeration cycle system is supported by the motor, the power converter, or the storage battery.

9. The cooling apparatus according to claim 6, wherein, while the circulation of the cooling water in the second flow passage is stopped, the cooling water is cooled through the evaporator of the refrigeration cycle system.

10. The cooling apparatus according to claim. 6, wherein, when the heat generation amount of the cooled body is larger than a predetermined value, the cooling apparatus switches the flow passage of the cooling water of the water cooling system from the first flow passage to the second flow passage using the flow rate control unit and circulates the cooling water in the second flow passage.

11. The cooling apparatus according to claim 10, wherein, in a state in which a compressor of the refrigeration cycle system is stopped and the circulation of the cooling water in the first flow passage is stopped, the cooling apparatus circulates the cooling water in the second flow passage, and after a water temperature of the cooling water in the second flow passage rises and is equal to a water temperature of the cooling water in the first flow passage, the cooling apparatus starts circulation of the cooling water in the first flow passage.

12. The cooling apparatus according to claim 6, wherein the first flow passage and the second flow passage share a unit for pressure-feeding the cooling water.

13. The cooling apparatus according to claim 12, wherein the pressure-feeding unit is a pump.

14. The cooling apparatus according to claim 12, wherein the first flow passage and the second flow passage have a shared portion, and the pressure-feeding unit is provided at the shared portion.

15. The cooling apparatus according to claim 6, wherein each first flow passage and second flow passage comprises a temperature sensor which detects a water temperature of the cooling water circulating therein, and the flow rate control unit controls the flow rate of the cooling water flowing in the first flow passage and the second flow passage based on the temperature sensor.
